(19) United States
(12) Patent Application Publication
(10) Pub. No.: US 2016/0305598 A1
(43) Pub. Date: Oct. 20, 2016

(54) Method of Manufacturing Vacuum Insulation Panels

(71) Applicant: SONOCO DEVELOPMENT, INC., Hartsville, SC (US)

(72) Inventor: Ajit Ranade, Naperville, IL (US)

(73) Assignee: Sonoco Development, Inc., Hartsville, SC (US)

(21) Appl. No.: 15/038,498

(22) PCT Filed: Feb. 24, 2015
(86) PCT No.: PCT/US2015/017211

§ 371 Date: May 23, 2016

Related U.S. Application Data
(60) Provisional application No. 61/944,890, filed on Feb. 26, 2014.

(51) Int. Cl. F16L 59/065; B33Y 10/00; B33Y 80/00; B29C 65/00; B32B 27/36; B32B 15/08; B32B 15/20; B32B 27/08; B32B 27/30; B29C 67/00; F16L 59/02

(52) U.S. Cl. CPC F16L 59/065; B29C 67/0051; B33Y 10/00; B33Y 80/00; B29C 66/00145; F16L 59/029; B32B 15/08; B32B 15/20; B32B 27/08; B32B 27/302; B32B 27/365; B29K 2105/04

(57) ABSTRACT

A method is provided of manufacturing a vacuum insulation panel using three-dimensional printing technology. Individual layers of core material are built up to produce a rectilinear core having a very small internal wall thickness and numerable hollow areas, thus creating a core having a highly porous surface. The highly engineered porous core is then encapsulated in a plastic, aluminum or composite envelope and a vacuum is applied. Once all or most of the gas molecules are removed, the engineered VIP delivers a high level of insulation.

### BACKGROUND OF THE INVENTION

1. Field of the Invention

This invention relates to a method for manufacturing vacuum insulation panels. More particularly, this invention relates to a method for manufacturing vacuum insulation panels using three-dimensional printing technology.

2. Description of the Related Art

### Vacuum Insulation Panels

A vacuum insulation panel (VIP) is a product composed of a rigid, highly-porous “nano” size material core that is surrounded by an enclosure (envelope) that is vacuum packed and nearly hermetically sealed so as to remove any remnant air particles within the enclosure. The envelope typically is made of multilayer plastic film (such as polyethylene (PE), Nylon, ethylene vinyl alcohol (EVOH) or metalized polyester) or aluminum foil.

The principal reason why VIPs are highly sought after as material for use in insulation is due to their exceptionally high thermally insulating properties. For example, expanded polystyrene (EPS) and polyurethane, which are typical insulating materials, have a thermal resistance (R value) of about 4-4.5 and 5-6 hr-ft²-° F./BTU-in respectively, whereas the R value for a VIP of the same thickness is typically 35-40 hr-ft²-° F./BTU-in or more. In order for EPS or polyurethane to be as effective as a VIP, the same EPS or polyurethane sheets would need to be made about seven or eight times thicker.

### Heat Transfer

Heat transfer through a volume of space can occur by three modes: convection, conduction and radiation. Creating a vacuum within a VIP or other insulator reduces convection, since convention relies on the presence of gas molecules able to transfer heat energy by bulk movement through the insulator. The lack of air molecules also reduces conduction because there are fewer collisions between adjacent gas molecules. For example, a VIP core at atmospheric pressure (about 1000 millibars (mbar)) may have anR value of 5 hr-ft²-° F./ BTU-in. Reducing the internal pressure within the VIP core to 1 mbar can increase the R value to 40 hr-ft²-° F./ BTU-in, an eight-fold increase. Reducing internal pressure to 0.1 mbar, which is extremely difficult to achieve and maintain, can increase the R value to 100 hr-ft²-° F./ BTU-in. The R value for a typical VIP is about 32-36 hr-ft²-° F./ BTU-in.

### Choice of Core Material

The choice of core material (substrate material) in VIPs is extremely important in achieving the desired high insulation properties. A good core material should possess three important properties: low thermal conductivity, low bulk density and high surface area. It is not easy to find a core material which possesses all three properties.

The most common materials used in making a VIP core are fumed silica and glass fiber. Fumed silica, also known as pyrogenic silica, consists of microscopic droplets of amorphous silica fused into branched, chain-like, three dimensional secondary particles which then agglomerate into tertiary particles. The resulting powder has extremely low bulk density and high surface area.

Glass fiber is manufactured by melting glass at very high temperature followed by extruding strands that can be woven into a mat. Glass fibers used in VIP manufacturing have low bulk density and high surface area.

These core materials are used for other applications, not just for VIPs. For example, fumed silica is used as a thickening agent in paints, coatings, printing inks and adhesives. Glass fiber is a common material used in industrial insulation application.

### Core Wall Thickness and Pore Size

As noted above, the core wall thickness and pore size are important factors contributing the insulative properties of the VIP. Reducing the wall thickness of the core to the nanometer level can reduce the mean free path of the gas molecules, thus reducing gas to gas thermal conduction and improving the insulative properties of the VIP.

It is very critical that the pore size of core material be very small and ideally smaller than 60 nanometers (nm), which is equal to the mean free path of gas molecules at ambient temperature and pressure. Fumed silica pore size is much smaller than glass fiber. VIPs made out of fumed silica can achieve a thermal conductivity of less than 0.002 W/mK at ambient temperatures. It is not possible to achieve this level of insulation using glass fiber as a core material. The present disclosure relates to a method for making a VIP with a pore size similar to or less than that achieved with fumed silica.

### Edge Leaks

A typical VIP shipper is made by assembling five individual VIP panels and securing the panels together using packaging tape or strapping using band strap. Despite the care given to assembly, there can be significant air gaps (edge leaks) formed during the assembly. These gaps are almost impossible to eliminate due to the often uneven shape of VIP panels around the edges. Even though individual panels may have an R value of up to 40 hr-ft²-° F./ BTU-in, in the overall shipper the R value may be anywhere between 25-30 hr-ft²-° F./ BTU-in, a 25-30% drop. The drop in R value is due to the edge leaks. This is one of the reasons packaging systems consisting essentially of VIP panels fitted together have difficulty being successful in the insulated shipper market. They are expensive, and their insulative benefits are greatly compromised due to edge leaks.

Edge leaks in general occur when two adjoining walls of material are not completely in contact/flush with one and another and therefore create a (sometimes) visible gap, also known as a thermal bridge. This thermal bridge creates a path of least resistance for heat to transfer through, thus making even high R value materials ineffective at preventing thermal transmissions. The R value of the entire system is compromised and languishes to levels of systems with no VIP panels. Simply adding additional thermal insulation to the enclosure within the shipper is of little benefit. Rather, the thermal bridge must be minimized or eliminated completely in order for the system's R value to be substantially enhanced.

For this reason it is desirable to have a rectilinear core and thus VIP, one with “sharp” (linear), ninety degree edges that can better mate with adjacent VIPs. Cores made from fumed silica powder are difficult to shape into a rectilinear structure.

The present invention is designed to address these problems.

### BRIEF SUMMARY OF THE INVENTION

The present invention is a method of manufacturing vacuum insulation panels using three-dimensional printing technology. Using 3D printing technology, individual layers are built up to produce a core with a very small wall thickness and numerable hollow areas, thus creating a structure having a highly porous surface. The highly engineered porous core is then encapsulated in a plastic, aluminum or composite envelope and then vacuum is applied. Once all or most of the gas molecules are removed, the engineered core delivers a high level of insulation.

The method may comprise the following steps:

(a) Providing a porous core material for use in manufacturing the core. The core material may be nylon, acrylonitrile butadiene styrene (ABS), polycarbonate, polyetherimide (ULTEM™) or any suitable material that can be laid down to form a highly porous, rectilinear structure.

(b) Dispensing the core material from a three-dimensional printing device to produce a core comprising multiple layers of core material. Each layer of core material should have a highly porous surface in order to create lots of tunnels or voids. The walls that make up the core structure should be thin, preferably between about 90 microns and about 130 microns in thickness. The resulting core is an “interwoven” structure of interconnecting walls made by building up layers of porous core material into a rectilinear shape, preferably one having sharp (linear) edges.

(c) Encapsulating the core in an envelope. The envelope or “bag” may be made of plastic, aluminum, composite or any suitable material capable of retaining a vacuum.

(d) Applying a vacuum to the encapsulated core to remove gas molecules within the envelope.

(e) Sealing the envelope to produce the vacuum insulated panel.

### BRIEF DESCRIPTION OF THE DRAWINGS

FIG. 1 is a flow chart showing a method of manufacturing a vacuum insulation panel according to the disclosure.

FIG. 2 is a perspective view of a vacuum insulation panel according to one aspect of the disclosure shown being assembled.

FIG. 3 is a perspective view of a vacuum insulation panel according to another aspect of the disclosure shown being assembled.

FIG. 4 is a perspective view of a vacuum insulation panel according to a third aspect of the disclosure shown being assembled.

### DETAILED DESCRIPTION OF THE INVENTION

While this invention may be embodied in many forms, there is shown in the drawing(s) and will herein be described in detail one or more embodiments with the understanding that this disclosure is to be considered an exemplification of the principles of the invention and is not intended to limit the invention to the illustrated embodiments.

The present invention is a method of manufacturing a vacuum insulation panel (VIP) using 3D printing technology to produce the core. The core is designed to achieve a reduction in gas phase conduction and achieve maximum insulation.

### Three Dimensional Printing

Three dimensional (“3D”) printing, also known as additive manufacturing, is a process of making a three dimensional solid object of virtually any shape from a digital model. 3D printing is achieved using an additive process where successive layers of material(s) are laid down in different shapes. 3D printing is considered distinct from traditional machining techniques, which mostly rely on the removal of material by methods such as cutting or drilling (subtractive processes).

A 3D printer is a machine capable of carrying out the additive process via computer. The 3D printing technology is used for both prototyping and distributed manufacturing, with applications in architecture, construction, industrial design, automotive, aerospace, military, civil engineering, dental, medical industries, etc. A 3D printer can “print” in plastic such as nylon, acrylonitrile butadiene styrene (ABS), polycarbonate, polyetherimide (ULTEM™) and other plastic materials.

3D printers use a variety of different types of additive manufacturing technologies, but they all share one thing in common: they create a three dimensional object by building it layer by successive layer, until the entire object is complete. Each of these printed layers is a thinly sliced, horizontal cross-section of the eventual object.

### The Present Method

This disclosure relates to a method for manufacturing vacuum insulation panels using three-dimensional printing technology. Using 3D printing technology, individual layers are built up to produce a core with a very small internal wall thickness and innumerable hollow areas, thus creating a highly porous structure. Commercially available 3D printers that are capable of delivering an internal wall thickness of 90-130 microns may be used. The finished porous core may have a generally rectilinear shape.

The highly engineered porous core is then encapsulated in a plastic, aluminum or composite envelope and then vacuum is applied. Once all or most of the gas molecules are removed, the engineered porous core delivers a high level of insulation when used in packaging applications. The porous core can be designed for specific temperature assured packaging applications.

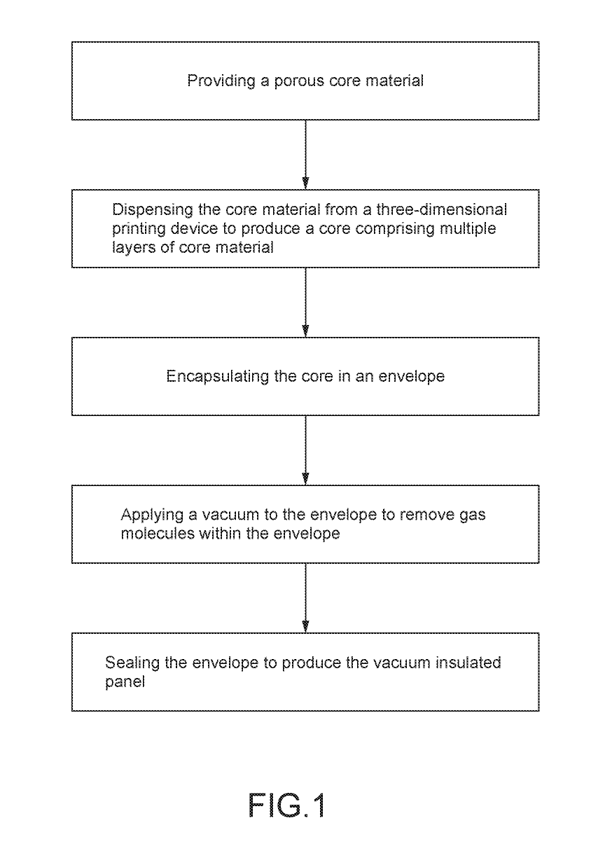

FIG. 1 is a flow chart showing a method of manufacturing a vacuum insulation panel according to the disclosure. The method may comprise the following steps:

(a) Providing a core material for use in manufacturing the porous core. The core material may be nylon, ABS, polycarbonate, polyetherimide (ULTEM™) or any suitable material that can be laid down to form a highly porous, rectilinear structure.

(b) Dispensing the core material from a three-dimensional printing device to produce a core comprising multiple layers of core material. Each layer of core material should have a highly porous surface in order to create a highly porous core with lots of tunnels or voids throughout. The internal walls that make up the core structure should be thin, preferably between about 90 microns and about 130 microns in thickness. The resulting core is an “interwoven” structure of interconnecting walls made by building up layers of core material into a rectilinear shape, preferably one having sharp (linear) edges.

(c) Encapsulating the highly porous core in an envelope. The envelope or “bag” may be made of plastic, aluminum, composite or any suitable material capable of retaining a vacuum.

(d) Applying a vacuum to the encapsulated core to remove gas molecules within the envelope.

(e) Sealing the envelope to produce the vacuum insulated panel.

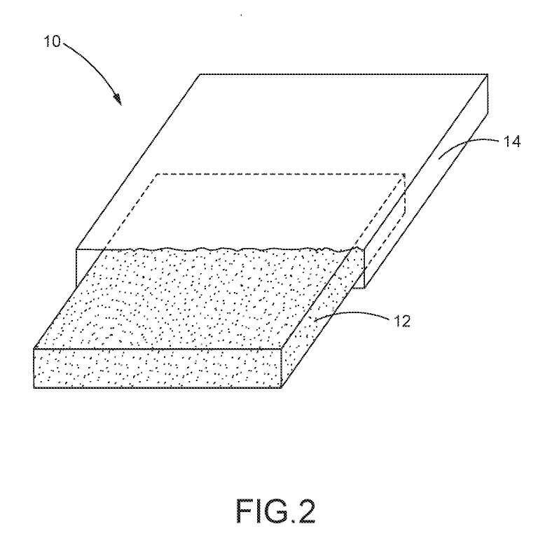

FIG. 2 is a perspective view of a vacuum insulation panel 10 according to one aspect of the disclosure shown being assembled. The vacuum insulation panel 10 comprises a porous core 12 and an envelope 14.

The porous core 12 may be made according to the methods described herein. The material that makes up the porous core 12 may be nylon, ABS, polycarbonate, polyetherimide (ULTEM™) or any suitable material that can be laid down by three-dimensional printing to form a highly porous, rectilinear structure. Preferably the core 12 has sharp (linear) ninety degree edges that can mate with adjacent VIPs to minimize or eliminate gaps between the adjacent VIPs. The average pore size of core material is very small and preferably smaller than 60 nanometers (nm).

The porous core should define lots of tunnels or voids. The internal walls that make up the porous core 12 should be thin, preferably between about 90 microns and about 130 microns in thickness. The resulting porous core 12 is an “interwoven” structure of interconnecting walls made by building up layers of porous core material into the final rectilinear shape.

The envelope 14 may be made of multilayer plastic film (such as polyethylene (PE), Nylon, ethylene vinyl alcohol (EVOH), metalized polyester) or aluminum foil or any suitable material.

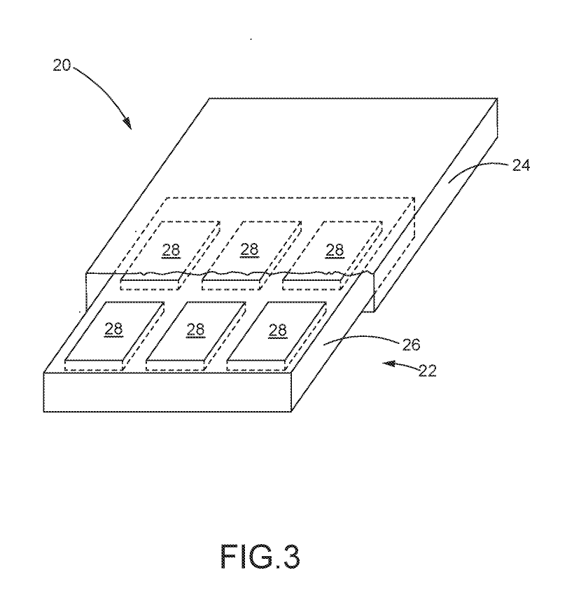

FIG. 3 is a perspective view of a vacuum insulation panel 20 according to another aspect of the disclosure shown being assembled. The vacuum insulation panel 20 comprises a core 22 and an envelope 24. The envelope 24 may be the same or similar to that of the first embodiment described above. The core 22 comprises a tray 26 defining one or more pockets, and one or more core members 28 nested within the pockets such that the core forms a three-dimensional structure with six substantially flat sides and sharp edges. The tray 26 and/or the core members 28 may be made using three-1 dimensional printing according to the methods describe herein. For example and without limitation, the tray 26 may be made using three-dimensional printing to create a highly porous structure with sharp edges and pockets, and then the pockets can be filled with fumed silica, glass fiber or other suitable insulating material. It should be understood that the pockets, and thus the core members 28, may be any suitable shape, including rectilinear, square, cylindrical and triangular. The shape of the pockets can be selected to increase the surface area of the core members and/or reduce the overall density of the core 22.

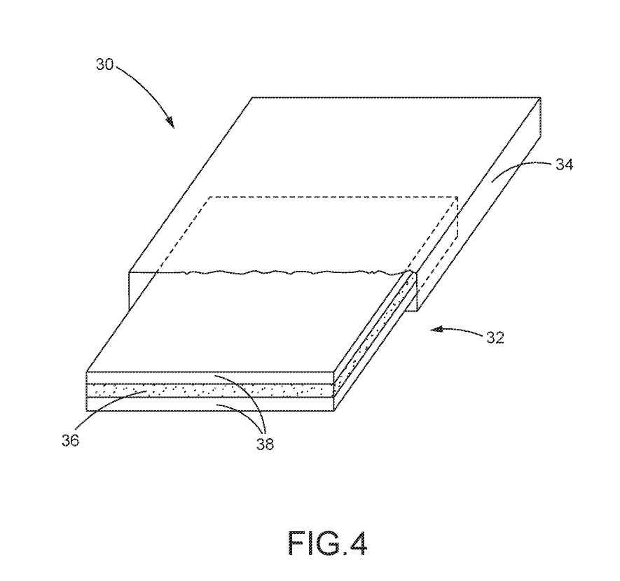

FIG. 4 is a perspective view of a vacuum insulation panel 30 according to a third aspect of the disclosure shown being assembled. The vacuum insulation panel 30 comprises a core 32 and an envelope 34. The envelope 34 may be the same or similar to that of the first embodiment described above. The core 32 comprises a plurality of layers stacked in a vertically aligned arrangement. More particularly, the core 32 may comprise layers made by three-dimensional printing (“3D printed” layers) and layers of fumed silica or glass fiber (“non-3D printed” layers). The 3D printed layers and non-3D printed layers may alternate vertically, or may be arranged vertically in some other order, including a random order.

For example, in the embodiment shown FIG. 5, the core 32 comprises a 3D printed layer 36 made by three-dimensional printing sandwiched between non-3D printed layers 38 of fumed silica or glass fiber. The 3D printed layer(s) 36 may be made using three-dimensional printing according to the methods describe herein.

The benefits of a vacuum insulated panel (VIP) made according to the disclosure include:

(1) The VIPs are relatively easy to manufacture, and require no complex manufacturing equipment.

(2) The VIPs are easy to design and form into various shapes.

(3) The VIP exhibits a high level of insulation characteristics.

(4) Because there is less edge loss than in a fumed silica VIP, the vacuum inside the sealed envelope need not be as high.

(5) 3D printing is a more environmentally friendly process compared to methods of forming VIP cores using fumed silica or glass fiber.

(6) VIPs with a 3D printed core are expected to have a longer life and be more reusable than a VIP with a fumed silica core.

### Applications

Three dimensional (3D) printing is a useful technology to create a core for a vacuum insulation panel. During 3D printing, individual layers of polymers are spread across the entire surface area. These layers are separated by thin walls which gives the core a highly porous structure. This highly porous polymer structure is not possible by any other industrial polymer processing technology. Until now, inorganic silica was commonly used in manufacturing of vacuum insulation panels. Three dimensional printing has allowed for the use of organic polymers in VIP applications.

A core made according to the disclosure may be encapsulated in an envelope and then subjected to a pulled vacuum to make a vacuum insulation panel, or VIP.

Alternatively, cores made according to the disclosure may be filled with a phase change material (PCM) and encapsulated in an envelope, but without a vacuum to form a PCM panel.

VIPs or PCM panels made according to the disclosure may be used to construct a box-like housing as part of a temperature assured shipper for use in shipping pharmaceuticals, vaccines, foods or any temperature sensitive payload.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

1. A method for manufacturing a vacuum insulation panel comprising the steps of:
(a) Providing a porous core material;
(b) Dispensing the core material from a three-dimensional printing device to produce a core comprising multiple layers of core material;
(c) Encapsulating the core in an envelope to produce an encapsulated core;
(d) Applying a vacuum to the envelope to remove gas molecules within the envelope; and
(e) Sealing the envelope to produce the vacuum insulation panel.

2. The method of claim 1 wherein:
the core material is selected from the group consisting of nylon, acrylonitrile butadiene styrene, polycarbonate and polyetherimide.

3. The method of claim 1 wherein:
step (b) includes producing a core having a highly porous, rectilinear structure.

4. The method of claim 1 wherein:
in step (b) each layer of core material has a highly porous surface.

5. The method of claim 1 wherein:
in step (b) the core comprises internal walls having a thickness between about 90 microns and about 130 microns.

6. The method of claim 1 wherein:
in step (c) the envelope is made of a material selected from the group consisting of plastic, aluminum and composite material.

7. A vacuum insulation panel comprising:
a core comprising a tray defining one or more pockets, and one or more core members nested within the pockets such that the core is a three-dimensional structure with six substantially flat sides and sharp edges; and
an envelope encapsulating the core.

8. The vacuum insulation panel of claim 7 wherein:
the tray comprises multiple layers of highly porous core material.

9. The vacuum insulation panel of claim 8 wherein:
the core members are made of an insulating material.

10. The vacuum insulation panel of claim 9 wherein:
the insulating material is selected from the group consisting of fumed silica and glass fiber.

11. The vacuum insulation panel of claim 9 wherein:
the core members are rectilinear.

12. A vacuum insulation panel comprising:
a core comprising a plurality of layers stacked in a vertically aligned arrangement to form a three-dimensional structure having six flat sides and sharp edges; and
an envelope encapsulating the core.

13. The vacuum insulation panel of claim 12 wherein:
the core 32 comprises at least one 3D layer comprising multiple layers of printed core material and at least one non-3D layer made of insulating material.

14. The vacuum insulation panel of claim 12 wherein:
the insulating material is selected from the group consisting of fumed silica and glass fiber.

15. The vacuum insulation panel of claim 13 comprising:
at least one 3D layer is located between non-3D layers.

16. The vacuum insulation panel of claim 15 wherein:
the 3D layer and non-3D layers are rectilinear.
